(19) United States
(12) Patent Application Publication
(10) Pub. No.: US 2014/0032337 A1
(43) Pub. Date: Jan. 30, 2014

(54) SYSTEM AND METHOD FOR OPTIMIZING ELECTRONIC COMMERCE VISIBILITY

(71) Applicant: Michael Beaulieu, Jacksonville, FL (US)

(72) Inventor: Michael Beaulieu, Jacksonville, FL (US)

(21) Appl. No.: 13/887,321

(22) Filed: May 5, 2013

Related U.S. Application Data
(63) Continuation-in-part of application No. 13/566,563, filed on Aug. 3, 2012, now abandoned.
(60) Provisional application No. 61/667,385, filed on Jul. 2, 2012.

(51) Int. Cl. G06Q 30/02

(52) U.S. Cl. CPC G06Q 30/0277
USPC 705/14.73

(57) ABSTRACT

A method for automatically disseminating information relating to an e-commerce transaction occurs automatically without requiring any action by the parties to the transaction. Upon completion of the transaction at an e-commerce transaction platform, for example, a website, information relating to the transaction is automatically posted on the platform is well as other networking websites. The multiple postings increases visibility for the parties, the product and the transaction across the Internet. The parties to the transaction may be incentivized to increase the number of postings made relating to the transaction.

### CROSS-REFERENCE TO RELATED APPLICATIONS

This application is a continuation-in-part to U.S. Utility application Ser. No. 13/566,563 filed Aug. 3, 2012 and claims priority to U.S. Provisional Application Ser. No. 61/667,385, filed Jul. 2, 2012, the contents of which are hereby incorporated in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD

The present invention relates to systems and methods for optimizing the visibility of commercial transactions conducted through one or more computer networks. More particularly, the invention relates systems and methods for enhancing the online visibility of the buying and selling of products and/or services utilizing a software platform readily available through the world wide web and capable of interacting with multiple other internet based platforms designed for interactions that are commercial, social, political, educational and/or business in nature.

### BACKGROUND

Interactive systems connected over wide area networks, such as the internet, have steadily evolved into vibrant mediums for social interaction and distribution of media and other content. Indeed, an enormous amount of digital media generated by end users, media companies, and professional media creators is made available and shared across the Internet through web sites and uploading to various content hosting or aggregation systems and services (e.g., Flickr®, Yahoo!®, YouTube®, etc.). End-users increasingly use or share media in a variety of on-line and interactive contexts. For example, an ever-increasing number of end-users create websites of various types, including blogs, personalized social networking pages (such as Yahoo®, Facebook®, or MySpace®), that utilize digital media content, such as images, video, and music.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated.

The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Such information handling systems have been instrumental in the widespread adoption of e-commerce, which enables organizations to communicate, advertise, market and sell their products and services over computer networks such as the internet. These same information handling systems have been just as instrumental in the rapid adoption of social media into the mainstream of everyday life. Social media commonly refers to the use of web-based technologies for the creation and exchange of user-generated content for social interaction.

More recently, social commerce has emerged. A subset of e-commerce, social commerce uses social interactions and user contributions to assist in the online buying and selling of products and services. More succinctly, social commerce can be thought of as the use of social media in the context of e-commerce. Examples of social commerce include customer ratings and reviews, user recommendations and referrals, private and public forums and communities, and social advertising.

Another form of social commerce is user-generated advertorial content, which provides on-line shoppers with advice from trusted individuals and assists them in finding recommended goods and services. Once restricted to e-commerce sites, such content is now beginning to be available within social media environments. However, purchasing recommended goods and services typically requires leaving the social media environment and accessing the vendor's e-commerce site. Once accessed, the user is often overwhelmed with too many choices, which can lead to confusion, indecision, and abandoned shopping carts. Furthermore, editorials, rating and other commentary by persons on the Internet are often suspect. Anyone, including an employee of the vendor may rates a vendor's products and services. Endorsements by persons a purchaser knows

If a vendor wishes to list an item for sale, there are three choices typically available. First, the vendor may create a website from which customers may purchase items directly. This is fairly common over the Internet, and is similar to operating a brick-and-mortar store in a downtown area. To draw purchasers to the website, the vendor typically must use advertising. In addition, Search Engine Optimization (“SEO”) has become a rapidly growing method of drawing purchasers to a vendor's website. SEO uses a variety of different and constantly evolving methods for improving a website's placement in search engine results. Both advertising and SEO are costly and consume substantial resources of the vendor. Both techniques also must be constantly modified to better target potential purchasers. This option alone generally provides very little in the way of reviews by persons a potential purchaser may know.

Another option open to vendors is to continue to sell to companies having brick-and-mortar stores and allow them to take care of online marketing. For example, an electronics company may continue to sell to Best Buy®, Walmart®, or other companies that maintain both brick-and-mortar and online stores. However, vendors are typically interested in maximizing sales in all venues possible. Thus, this option alone is generally considered insufficient to generate adequate sales.

Another option open to vendors is to find a website marketplace where they may post listings of items for sale. Website marketplaces, such as for example, eBay® and overstock.com® have an established web presence that draws purchasers to their websites. On some of these website marketplaces. Members may post reviews of vendors.

Purchasers on the Internet, have a very wide selection of options in selecting websites for purchasing items. This nimeity of choices may make selection of a item to purchase more difficult. It would be desirable for purchasers to find a website that allows them to obtain information from trustworthy sources about items being sold. It would also be desirable for vendors to have a website where they could post listings of items for sale that may automatically generate targeted advertising without the expense of online advertising and SEO.

In view of the foregoing, there is a need to seamlessly extend social commerce to provide complete e-commerce functionality from within a social media environment. Furthermore, what is needed is a platform that lets a user catalog an item publicly on a network while exposing an item in a seemingly social way.

### SUMMARY

Accordingly, the primary object of the present invention is to provide a computer network based system for optimizing visibility of commercial transaction that occur over a computer platform accessible through the internet or other computer network. In addition, the system may include simultaneous postings of goods and services for sale in an open platform over both social networks and listing services.

In greater detail, the system includes a computer-implementable method, such as a platform, for conducting e-commerce within a social network website and a listing service. The system includes enabling generation of a plurality of a social commerce user profiles, such as for example a profile page. Each identity may include data on a product, service or other object of sale, wherein each of the plurality of social commerce user profiles is operable to post a listing comprising data relating to goods or services the user of the profile may wish to buy, sell or request. The data may include a vendor of the product, prices, costs, purchasers, demographics of purchasers or vendors, and details about the item being listed. The method also includes reposting a listing associated with a profile. Reposted listings may be associated with other social commerce user profiles within a platform such that the data of the listing is dispersed among an identities belonging to an internal group associated with the profile generating the listing on the platform. The method also includes reposting data of a listing on other platforms, such as for example social network websites. The platform also performs e-commerce operations associated with the product, such as for example purchasing transactions.

In a further embodiment, the system includes a processor; a data bus coupled to the processor and a computer-usable medium embodying computer program code. The computer-usable medium is coupled to the data bus, the computer program code interacting with a plurality of computer operations and comprising instructions executable by the processor and configured for enabling generation of a plurality of a social commerce sites within in operation with a central social network. Each of the plurality of social commerce user profiles may include multiple listings of products, services or other data.

In one embodiment, a computer-usable medium embodies computer program code, the computer program code comprising computer executable instructions configured for enabling generation of a plurality of a social commerce user profiles. Each of the plurality of social commerce user profiles includes product data, wherein each of the plurality of user profiles is operable to perform electronic commerce operations and the product data is associated with a vendor of the product; performing governance operations on the plurality of social commerce sites via a central social network. The system further includes receiving social commerce input data from the user of the central social network, wherein the social commerce input data is processed to perform electronic commerce operations associated with the product.

It is therefore an object of the present invention to provide a method, system and device for automatically disseminating information relating to e-commerce that increases the online visibility of the parties to a transaction without requiring action by either of the parties.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagrammatic representation of how information relating to an e-commerce transaction may be disseminated in accordance with the principles of the present invention;

FIG. 2 is a diagrammatic representation of how information relating to an e-commerce transaction may be disseminated in accordance with the principles of the present invention;

FIG. 3 is another diagrammatic representation of how information relating to an e-commerce transaction may be disseminated in accordance with the principles of the present invention;

FIG. 4 is another diagrammatic representation of how information relating to an e-commerce transaction may be disseminated in accordance with the principles of the present invention;

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Disclosed is an e-commerce system for selling and purchasing goods and services over a social or other network that may utilize a simple one-click posting method wherein, upon a user's posting of a listing of an item for sale, the listing may be automatically reposted to other profiles or other platforms without need of additional action by the user. The e-commerce system may include an e-commerce platform, such as for example an e-commerce networking website, to which other social or e-commerce websites, or other platforms, may be connected. The system may include the automatic, simultaneous repostings of a listing for goods and/or services for sale on one or more social, e-commerce or other platforms, such as for example a website, in an open platform over both additional networks and traditional listing services.

In greater detail, a platform, such as for example an e-commerce networking website, in accordance with the principles of the invention may enable a user to generate a plurality of postings with one click. The term “one click” is used herein to express an aspect of the functionality of a system whereby, upon the posting of a listing by a user, several repostings of the listing occurs automatically. When a user wishes to post a listing of a product or service to buy, sell or request an item with one click, he or she may connect to a user profile within a platform which may be associated with one or more networks internal to the platform, such as friend networks or groups. The user's profile on the platform may also be associated with a credit card, checking account, deposit account or other payment system in order to facilitate transfer of funds electronically.

The system may enable a user to buy or sell an item. A user may create a user profile using a platform in accordance with the principles of the invention. As used herein, “user's profile” generally refers to a page on a website accessible to members, and optionally also nonmembers, that displays information about a particular user. For example, Facebook® allows each member to create a user profile listing information about that user. A Facebook® user may connect his or her profile to user profiles of other persons on the platform, in this case, a website. Optionally, a user may choose to connect a user profile to various groups on the platform, which act as a subgroup network within the platform. Other platforms, such as for example, LinkedIn®, provide a similar service, but targeted toward users having a different purpose. Facebook® is typically used for purely social purposes, while LinkedIn® is typically used to establish business connections and network.

A platform in accordance with the principles of the present invention may be similarly comprised of a website where users may create user profiles. As used herein, “platform” generally refers to an e-commerce networking website. However, it is to be understood that “platform” may also refer to any medium through which a plurality of persons or business entities may interact and conduct business transactions. The platform may allow users to connect their profiles to groups and/or create friend networks. As used herein, a “user” may generally refer to a purchaser, a seller or another entity interested in e-commerce transactions. Users may post on the user profile any information it chooses. Optionally, users may belong to groups, or connect user profiles similar to how a user may make a “connection” on LinkedIn® or “friend” someone on Facebook®.

Users may also provide the platform with confidential information that may not be posted and may include credit card or other account numbers and information, bank account information, and usernames and passwsords for other networking websites where the user may also have a profile, and any preferences a user may have regarding which websites the user may or may not want to be used to disseminate information regarding the user's e-commerce activities.

Users may also post information relating to e-commerce. The postings may include listings of items for sale, items the user wishes to purchase, items previously purchased or sold by the user, recently conducted transactions, or any other information relating to the user's e-commerce activities. All of these possible postings may be generally referred to as a “commercial event.” Defined rather broadkly, a “commercial event” may be any of the above explicitly identified postings, or other information that a user may wish to share with others interested in e-commerce. In addition, a commercial event may include events that are not posted by the users, but which are nevertheless facilitated by the platform. For example, a user may purchase a product from another user without specifically posting information relating to it on its user profile. When the users conduct a transaction using the platform, then information relating to it may still be recorded by the platform.

Anyone having access to a user's profile may view the postings. As with other websites, other users may be able to comment on, or “like” a post. When a user conducts a commercial event, whether the user specifically creates a posting on its user profile or not, the platform may automatically record information relating to the commercial event and “repost” the information onto the profile pages of other users within the user's groups or networks within the platform.

The platform may use information recorded relating to a commercial event and generate an announcement, which may be a type of secondary posting for reporting the event to persons who may be interested in knowing that the commercial event has take place. The announcement may include the names of any users or other persons involved with the commercial event, the date and time the event took place, a link to the original post, a link to a website that may provide additional information about the product or good sold, a link to a website owned or operated by a person or business involved with or related to the event, and more general information. Optionally, users may select what information is recorded for various commercial events.

The platform may also automatically post or publish an announcement generated regarding an event on another website, such as for example a social networking website. Thus, with just one “click,” one action taken on the platform, the user generates postings regarding a commercial event on his or her user profile, on other connected profiles, throughout groups, and on other social networking websites. The platform may automatically post an announcement to external platforms or networks, such as, for example, the user's profile page on other platforms such as Facebook®, Twitter®, Instagram® or LinkedIn®, Craigslist®, Amazon®, eBay® or the like. These announcements, which may also be called “reposts,” (and similarly “reposting” may also refer to posting an announcement) may include some or all of the information regarding the originating commercial event, a copy of an original post, a link to the listing, a link to one or more websites related to the user(s) involved in the transaction, links to websites relating to the products or services involved in the commercial event, and/or any other desired information. When another party responds to a post or listing, such as for example by buying an item listed, providing a price quote for an item desired, or other information relevant to the posting, that response may similarly be disseminated by reposting (i.e. posting an announcement) in a manner similar to the reposting of the original listing. The responsive listing may also be reposted in or through networks or groups to which a responding user belongs. Thus, posted information regarding a listing, purchase or other event and responses to the event may be automatically disseminated by reposting to a plurality of other user profiles and other networks. As a result the listing and the responses to it may be displayed at locations where they are likely to be viewed or observed by persons interested in such, and related, transactions.

When a platform disseminates information regarding e-commerce by posting announcements, several benefits may inure to the user(s) who initiated the commercial event, as well as by any user that may post a responsive listing or post. Reposts may optionally include links to the original post. This likely generates traffic to a user's profile. Additional traffic may result in additional purchases and thereby benefit a user. Because the reposts may be placed on user profiles that belong to the same groups, networks or subgroups as the user who posted the listing, the repost may serve as very specific, selective and direct targeted marketing. Users of the platform may select to join groups or networks on the platform based upon demographic similarities, geographic similarities as well as similarities in buying and spending habits.

Another advantage may be obtained from the proliferation of listings and links generated by the platform. Search engines as well as various companies often use software known as web crawlers or bots to locate links and other applications or widgets or other devices throughout the Internet. Web crawlers and bots may identify the links and other information in the reposting which may result in the user profile shifting to a better ranking on search engines. This may generate additional traffic also. This traffic may also be somewhat directed because it will be found by people performing searches relevant to the listing. Internet marketers generally refer to a rapid proliferation of an object over the Internet as “viral.” When an item on the Internet “goes viral” it becomes very well known by a very large audience in a very short amount of time. Such exposure may generally be deemed highly valuable in the world of Internet marketing. However, causing anything to “go viral” may be extremely difficult using prior art technology. The reposting using a one click mechanism may act to crime. The “going viral” process. Further, when a user takes action upon a reposted listing, such as for example, purchasing an item listed, that response to the original listing may itself be automatically reposted from the responding user's profile. The reposting initiated by the responding user's actions may generate additional purchases. These additional purchases may in turn generate automatically postings. This process may result in a cascade or chain reaction manner greatly proliferating the original listing and thereby automatically cause a listing to “go viral.”

In one embodiment, vendors may post listings free of charge. A vendor may only pay a fee upon the purchase of an item listed. Thus, not only may the information of a listing be disseminated in a directed, targeted manner, but a vendor may only incur expenses when a sale is made. As a result, the only costs incurred may be direct costs of actual sales. That is, the only advertising a vendor may pay for may be ones that directly result in a purchase.

The method may also include accessing at least some of the social and business network sites within the social network. Information regarding the listing may thus be reposted among the plurality of external platforms.

In a further embodiment, the system includes a processor; a data bus coupled to the processor and a computer-usable medium embodying computer program code. The computer-usable medium is coupled to the data bus. The computer program code interacts with a plurality of computer operations and comprising instructions executable by the processor and configured for enabling generation of a plurality of a user profiles within a platform.

A further embodiment includes a computer-usable medium embodying computer program code, the computer program code comprising computer executable instructions configured for enabling generation of a plurality of a user profiles. Each of the plurality of user profiles may include information relating to the user, wherein each of the plurality of the user profiles may be operable to perform e-commerce transactions, such that for example a user need only respond to a listing, for example with a purchase, without being required to perform several steps to complete the transaction.

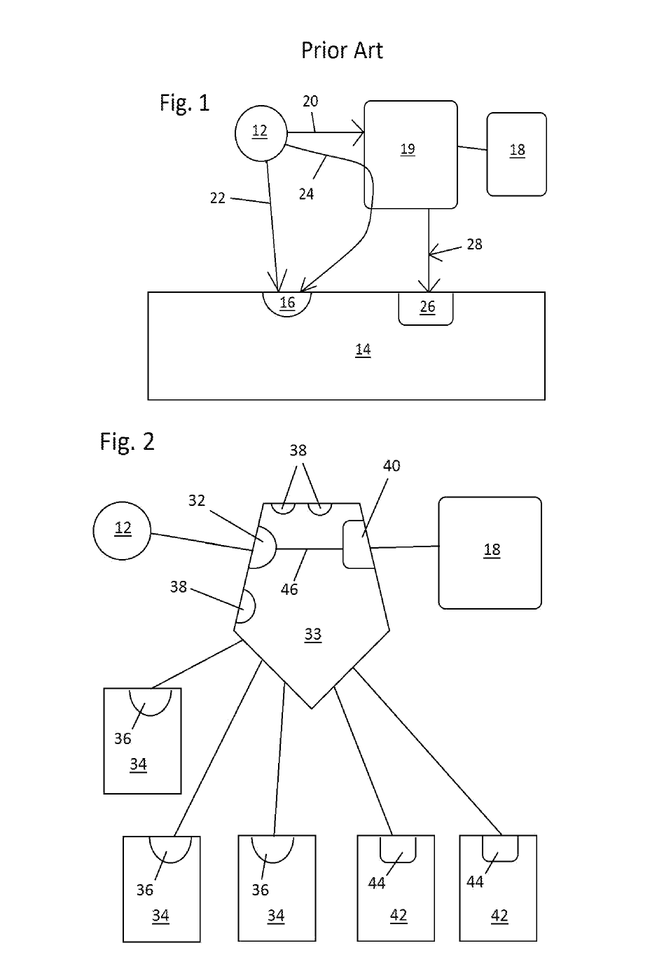

FIG. 1 shows a diagram illustrating the current state of the art and how it may be used to conduct an e-commerce transaction and how information relating to a listing may be disseminated. A buyer 12 may connect to a seller's website 19 which is operated by a person or business entity 18. The buyer 12, then conducts an e-commerce transaction 20 at the buyer's website 19. This alone does not generate an online posting of any information relating to the e-commerce transaction 20. To post information regarding the transaction 20, a user, a buyer or both must post the information relating to the transaction 20

Many seller websites allow a buyer 12 to send instructions 24, resulting in a posting of information relating to the e-commerce transaction 20 on a buyer's profile page 16 of a social network website 14. The buyer's website 18 may choose to post information 28 relating to the e-commerce transaction 20 at its own profile page 26 on the social network website 14. Optionally, the buyer 12 may choose to send information relating to the e-commerce transaction 22 and post it at the buyer's profile page 16 on the social network website 14.

In the current state of the art, it is unlikely that information relating to the e-commerce transaction 20 will be posted on the buyer's profile page 16 or the seller's profile page 26. Posting information relating to the e-commerce transaction on the buyer's profile page 16 generally requires an extra proactive step by the buyer 12 to post any information. The buyer 12 has little or no motivation to post the information on its profile page 16 of the social network website 14. The buyer 12 is therefore unlikely to independently disseminate information relating to the e-commerce transaction 22 on its profile page 16. Similarly, the buyer 12 also has little or no motivation to proactively request that the seller's website 18 post information on the buyer's profile page 16 of the social network 14. Posting this information provides little or no benefit to the buyer. Similarly, posting information relating to the e-commerce transaction 20 provides little benefit to the seller.

FIG. 2 shows a diagram of a system for disseminating e-commerce transaction information in accordance with the principles of the invention. Here, a buyer 12 may have a user profile 32, at an e-commerce platform 33. The seller 18 may be linked to the seller's profile 40 on the e-commerce platform 33. The e-commerce platform 33 may include a plurality of profiles 38, for a plurality of sellers and buyers, some profiles 38 may be for persons who are both buyers and sellers. As with many network websites, such as for example, Facebook®, LinkedIn® and Twitter®, each profile may be linked to a plurality of other profile pages as “friends,” “connections,” “followers” or the like.

The seller 12 may post an listing of an item for sale on its profile 40, which may then trigger the software of the e-commerce platform 33 to perform several functions. The e-commerce website may automatically inform profiles 38 of the posting of an item for sale. Which profiles 38 are selected for automatic posting of the new sale listing by seller 12 may depend on a variety of factors including whether the profiles 38 are part of a group or friend network for which the seller is also a member, the geographic proximity of the seller and owners of the profile pages 38, demographic information indicating that the owners of the profile pages are likely to be interested in the item posted, past buying or selling patterns of the owners of the profile pages 38 or other factors. As a result, information relating to the posted the item for sale may be posted on several profile pages 38 throughout the platform 33 in a manner that is readily accessible through the Internet. The information relating to the e-commerce transaction may include number of units, price, details relating to the product, ratings of the product, ratings of the buyer, ratings of the seller and other information.

A purchaser 12 may then conduct an e-commerce purchase transaction 46 directly between the buyer's profile 32 and the seller's profile 40. When an e-commerce transaction occurs between profiles on the e-commerce website 33, this may automatically trigger the software of the e-commerce platform 33 to perform several functions. The e-commerce platform may automatically inform other profiles 38 connected to the buyer's profile 32 or the seller's profile 40 of the e-commerce transaction 46. The other profiles 38 may simply receive a notification or optionally, the e-commerce platform 33 may publicly post information relating to the transaction on each of the connected profiles 38. As a result, information relating to the original listing and the purchase transaction 46 may be posted in a manner that is readily accessible through the Internet. The information relating to the e-commerce transaction may include number of units, price, details relating to the product, ratings of the product, ratings of the buyer, ratings of the seller and other information.

The e-commerce transaction platform 33 may also post information relating to the original listing and/or the purchase transaction on one or more of the buyer's profiles 36 on one or more other networks. For example, the seller may choose to designate any external, third-party networking website 34 for automatic posting by the e-commerce platform 33. As a result, any time a seller 12 posts a listing and/or conducts a transaction on the e-commerce platform 33 information relating to that transaction is automatically posted on each designated profile page 36 on each external networking website 34. Similarly, a buyer may designate its profiles 44 on external networking websites 42 for automatic posting of information relating to any transaction it takes part in on the e-commerce platform 33.

As a result of the “one click” function of the e-commerce website, information relating to the transaction may be posted numerous times on numerous websites. Web crawlers and other Internet robots may detect these multiple postings and as a result, the sellers, buyers and products rankings on Internet search engines will improve. Thus, both the buyer and seller may be motivated to utilize the e-commerce transaction website 33 in order to optimize themselves for search engines. Both parties increase their web presence, generating both direct and indirect marketing automatically generated as a result of an e-commerce transaction. Thus the advertising/marketing may always pay for itself. No cost to the buyer may be generated in the absence of a sale. Further, the dissemination of information relating to the sale increases the likelihood of others on the e-commerce website connecting to their profile pages, further increasing web presence, directed marketing and thus sales. Both parties may be thereby encouraged to use the website 33 to maximize the number of posting locations and occurrences automatically generated by the website 33.

Profiles 32, 38 and 40 on the e-commerce platform 33 may be connected because the owners of those profiles have similar transaction histories. That is, the sellers connected to one another typically may sell similar products or market to the same demographic. Similarly, buyers may be typically connected because they purchase the same products. As a result, the number of profiles connected to any particular profile may be more directly linked to their reliability, product choices, tastes, and the like, rather than upon popularity or other factors typically predominating connections between profile pages on other websites. Thus, information relating to the transaction may be not only multiplied, but may also be directed to the profiles of persons more likely to purchase or sell or otherwise engage in similar transactions. Thus, unlike postings on Facebook or LinkedIn, postings on the e-commerce platform 33 and the automatically generated postings resulting from transactions on website 33 provide directed marketing for the buyer and seller as opposed to indirect marketing. Such directed marketing may be substantially more valuable to both the buyer and seller.

One of the benefits of an e-commerce platform 33 in accordance with the principles of the invention may be that with the conducting of a single transaction. Both the buyer and the seller, and the product, immediately may establish substantially more of a web presence by means of a simple “one click” process. The software of the e-commerce platform 33 may also provide directed and thus more valuable, marketing for the buyer, the seller and the item itself.

In addition, it may be desirable for the e-commerce platform 33 to charge a buyer a nominal fee such that the e-commerce platform 33 may generate income for itself. This may provide a substantial benefit to the seller 18. Instead of paying per click, such as with Google ads and similar services, the seller 18 may only pay a fee when a transaction is conducted. This may provide a substantial benefit over other advertising systems that charge per click, thereby charging a seller any time a person visits its website, regardless of whether or not a purchase is made. The e-commerce platform 33 only charges a seller when a purchase is actually made. In addition, the fee paid per purchase also provides the directed marketing of the invention.

It may be desirable for the e-commerce platform 33 to identify an approximate location for both the buyer and seller. The e-commerce platform 33 may use this information to disseminate information relating to the e-commerce transaction 46 to profiles 38 on the e-commerce transaction website 33 that are geographically close to the buyer and/or seller.

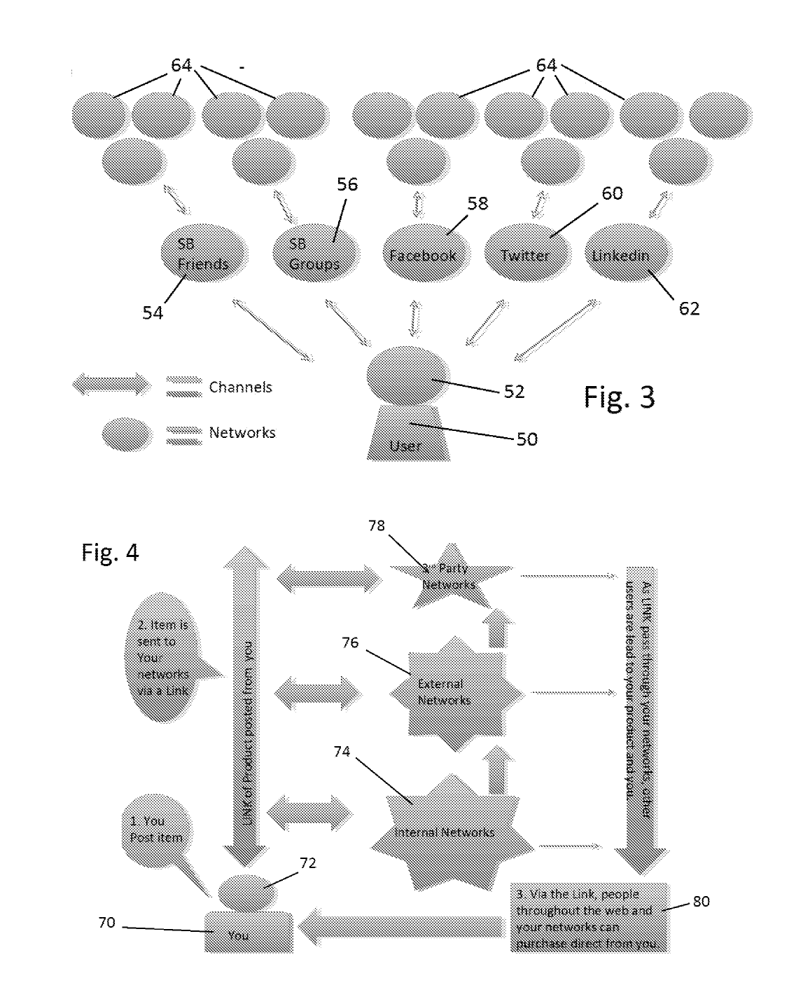

FIG. 3 shows another diagrammatic representation of the dissemination of information related to postings and purchases in accordance with principles of the invention. A user 50 accesses the e-commerce platform 52, where he or she may post an item for sale, information regarding a desired item for sale or other information relevant to e-commerce transaction. The posting on the e-commerce platform 52 may be automatically re-posted on profile pages belonging to the group 54 comprising friends of the user 50. The posting may also be reposted on profiles belonging to other groups 56 of which user is a member. Optionally, the information may be reposted on external networks such as Facebook® 58, twitter® 60 and/or LinkedIn® 62. Using the user's profiles on those websites. From there, the postings may be viewed and/or reposted and a cascade or viral manner, spreading information about the listing across various and sundry other networks and websites 64.

FIG. 4 shows another diagrammatic representation of how information may be disseminated in accordance with the principles of the invention. A user 70 may post an listing on the platform 72. Platform 72, then automatically reposts the listing on networks 74. Internal to the platform 72, such as friends or other groups. Platform 72 may also repost the listing on external networks 76, such as Facebook®, Twitter® and LinkedIn®. Platform 72 may also repost the listing on third-party networks 78 designated by the user. The listing may be further disseminated. This may generate a large audience 80, one of whom may respond to the listing by contacting the user 70 and initiating a transaction or follow-up posting.

Whereas the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A method for disseminating information relating to e-commerce comprising:
providing an e-commerce networking website;
recording information relating to a commercial event;
generating an announcement having the recorded information relating to a commercial event;
posting the announcement on the e-commerce networking website;
posting the announcement on at least one secondary website.

2. The method of claim 1 wherein the e-commerce website allows users to create a profile page and connect its profile page to other profile pages.

3. The method of claim 1 wherein the commercial event is facilitated by the e-commerce networking website and is selected from the group consisting of posting information relating to a user, offering an item for sale, identifying an item a user wishes to purchase, conduction a transaction, and commenting on a posting by another user.
